(19) United States
(12) Patent Application Publication
(10) Pub. No.: US 2006/0175744 A1
(43) Pub. Date: Aug. 10, 2006

(54) Positionable suction cup platform

(76) Inventor: Robert James Lemire, Kings Park, NY (US)

Correspondence Address: ROBERT J. LEMIRE, P.O. BOX 299, KINGS PARK, NY, 11754, US

(21) Appl. No.: 11/050,327

(22) Filed: Feb. 4, 2005

(51) Int. Cl. B23Q 3/00; B25B 3/00

(52) U.S. Cl. 269/289 R; 269/1; 269/20; 269/308

(57) ABSTRACT

A paste filled suction cup allows a platform to hold objects onto non-smooth surfaces. Laser levels and other devices can be affixed to this platform so that they can be quickly and easily placed on a wall. The action of the paste in the suction cup allows the suction cup to provide a temporary bond to the surface. The use of a water-soluble paste makes it easy to clean the wall after removing the suction cup. The paste also lets the platform be positioned by keeping it in the pasted area.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention generally relates to a platform employing one or more suction cups with a water soluble viscous paste for the temporary holding and positioning of a level indicating device on a non-smooth vertical surface.

There are a number of means employed for holding level indicating devices on a non-smooth vertical surface. A suction cup that is evacuated by a vacuum pump is one such means. However, such a device requires the use of an electrical source in the form of a battery or a wire connected to an outlet. Another limitation of current holding devices is that they have little to no ability to be positioned with a desired degree of accuracy. They have to be physically removed and then repositioned if they are not originally placed in the exact desired location.

The current invention uses one or more traditional suction cups filled with a water-soluble viscous paste to hold a platform onto a non-smooth surface. The paste seals around the cup and allows the suction cup to hold onto non-smooth vertical surfaces. The paste oozes out from around the edge of the cup when it is pushed against the surface. The extra paste around it allows the cup to be moved by simultaneously pushing it down and sideways without having to remove it from the surface. This allows the leveling device to be placed in the desired position and made perfectly level. The paste in the suction cup provides the short term holding required for this type of service. Removal of the device leaves a residue of the water-soluble paste that is easily cleaned up with a damp cloth.

### BRIEF SUMMARY OF THE INVENTION

In accordance with the preferred embodiment of the present invention there is provided a platform having one or more suction cups configured to hold one or more devices used for indicating a level line either vertically or horizontally. The platform is also configured so that it is parallel to the vertical surface it is being affixed to. The platform has one or more standard suction cups affixed to it. Prior to use the suction cups are filled with a water-soluble viscous paste.

In use the water-soluble paste is forced out of the suction cup as it is pushed down onto the surface. The paste forms a seal between the surface and the suction cup. This is what holds the platform onto the non-smooth vertical surface. Without the paste the suction cup would quickly loose its ability to hold onto the surface. This is a common problem with suction cups. Some suction cups try to use a special material around the outer edge of the cup to provide adhesion; however, it only takes a small groove to allow air to enter the cup and the bond is quickly lost.

Pushing the suction cup onto the surface establishes the initial position of the platform. The majority of the paste in the suction cup is expelled when it is pushed against the surface. This provides the ability to reposition the platform to a precise location by the smearing of the paste on the surface. If the device is moved out of the area covered by the paste it will come free of the surface. Additional paste can then be added to the suction cup so that it can be placed at the desired location.

### BRIEF DESCRIPTION OF THE DRAWINGS

These as well as other features of the present invention, will become more apparent upon reference to the drawings wherein:

FIG. 1 is a bottom plan view of the suction cup and platform assembly

FIG. 2 is an elevation view of the suction cup and platform assembly on a vertical surface with a laser level affixed to the platform

### DETAILED DESCRIPTION OF THE INVENTION

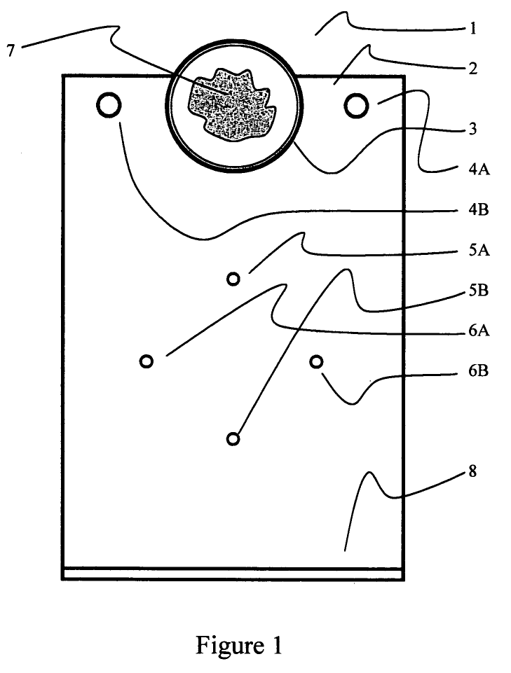

Referring now to the drawings wherein the showings are for purposes of illustrating a preferred embodiment of the present invention only, and not for purposes of limiting the same, FIG. 1 illustrates the platform assembly 1 composed of the platform 2 with suction cup 3 affixed to it. Water-soluble paste 7 is shown in the suction cup 3. Apertures 4A and 4B are optional suction cup locations in the event two suction cups are used. Apertures SA and 5B provide for the vertical holding of a level device. Apertures 6A and 6B provide for the horizontal holding of a level device.

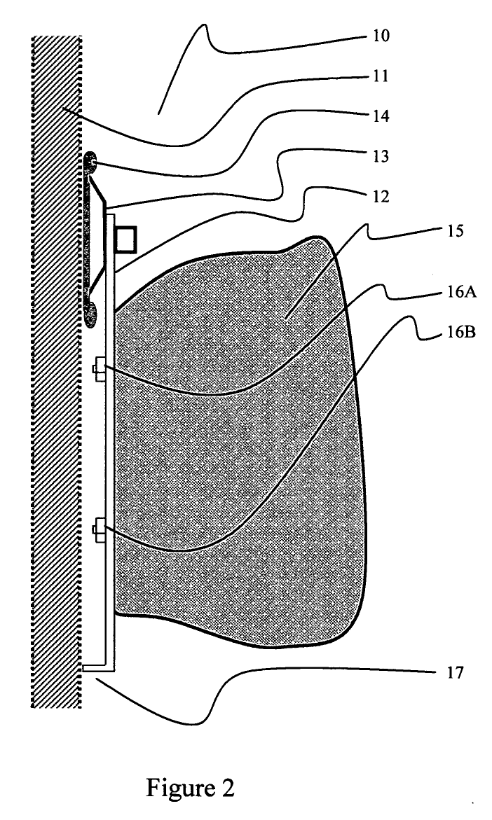

FIG. 2 shows assembly 10 being held onto a vertical surface 11 by the action of suction cup 13 and water-soluble paste 14. Laser level 15 is affixed to platform 12 with screws and nuts 16A and 16B. Lip 17 holds the platform parallel to the surface 11.

In use the platform 12 can be configured to hold any type of leveling device. The water-soluble paste 14 is the intermediary that couples the suction cup 13 onto a non-smooth surface 11. The paste 14 fills in the irregularities on the surface and allows the suction cup 13 to exert a holding force onto the surface 11. The low viscosity of the paste 14 keeps it from being quickly sucked into the suction cup 13 and allows it to provide the desired holding effect on a non-smooth surface. The additional paste 14 around the cup 13 allows the assembly to be moved over an area that can be covered by the paste. This feature allows the assembly to be moved into a precise location by simply pushing the assembly over to the desired location.

Additional modifications and improvements of the present invention may also be apparent to those of ordinary skill in the art. Thus, the particular combination of parts described and illustrated herein is intended to represent only a certain embodiment of the present invention, and is not intended to serve as limitations of alternative devices within the spirit and scope of the invention.

What is claimed is:

1. A platform configured to hold a leveling device and having a paste filled suction cup that holds said platform onto a non-smooth surface.

2. The system of claim 1 wherein the paste filled suction cup uses water-soluble viscous paste to form a bond between the suction cup and a non-smooth surface.

3. The system of claims 1 and 2 wherein the platform is configured to hold a leveling device such as a laser level.
